(19) United States
(12) Patent Application Publication
(10) Pub. No.: US 2024/0142955 A1
(43) Pub. Date: May 2, 2024

(54) PLANT MONITORING METHOD, PLANT MONITORING DEVICE, AND PLANT MONITORING PROGRAM

(71) Applicant: MITSUBISHI HEAVY INDUSTRIES, LTD., Tokyo (JP)

(72) Inventors: Ichiro NAGANO, Kanagawa (JP); Mayumi SAITO, Tokyo (JP); Kuniaki AOYAMA, Hyogo (JP); Keiji EGUCHI, Tokyo (JP)

(21) Appl. No.: 18/277,173

(22) PCT Filed: Mar. 7, 2022
(86) PCT No.: PCT/JP2022/009600

§ 371 Date: Aug. 14, 2023

(30) Foreign Application Priority Data
Mar. 9, 2021 (JP) 2021-037106

(51) Int. Cl. G05B 19/418

(52) U.S. Cl. CPC G05B 19/41865; G05B 2219/37591

(57) ABSTRACT

A method of monitoring a plant by using a Mahalanobis distance calculated from data of a plurality of variables each of which indicates a state of the plant includes: a dividing step of dividing a range of a single variable which indicates a state of the plant into a plurality of first range bands on the basis of a frequency distribution of the single variable; and a unit space creating step of creating a plurality of unit spaces which serve as a basis of calculation of the Mahalanobis distance on the basis of the respective data of the plurality of variables respectively corresponding to a plurality of second range bands of the single variable determined on the basis of the plurality of first range bands.

### TECHNICAL FIELD

The present disclosure relates to a plant monitoring method, a plant monitoring device, and a plant monitoring program.

The present application claims priority based on Japanese Patent Application No. 2021-037106 filed on Mar. 9, 2021 with the Japanese Patent Office, the contents of which are incorporated herein by reference.

### BACKGROUND ART

A plant may be monitored by using the Mahalanobis distance which indicates the difference between a standard data set of a variable which indicates the state of the plant (e.g., a state amount that is acquirable by a sensor) and measurement data of the variable.

Patent Document 1 discloses a plant monitoring method that uses the Mahalanobis distance and includes calculating the Mahalanobis distance using a plurality of unit spaces set in accordance with the operation period. Herein, the above described unit space is an aggregate of data used as a reference for determining whether the operation state of the plant is normal or not. More specifically, Patent Document 1 calculates the Mahalanobis distance of data acquired during the start operation period of the plant using a unit space created on the basis of the state amount of the start operation period of the plant, and calculates the Mahalanobis distance of data acquired during the load operation period of the plant using a unit space created on the basis of the plant state amount during the load operation period of the plant.

### CITATION LIST

### Patent Literature

Patent Document 1: JP5031088B

### SUMMARY

### Problems to be Solved

Meanwhile, it is considered possible to improve the abnormal detection accuracy by dividing the data of the variable indicating the state of the plant to be monitored into some groups according to some standard and calculating the Mahalanobis distance by using a plurality of unit spaces created in accordance with the groups, compared to a case where the Mahalanobis distance is calculated by using a single unit space created by using the above described data entirely.

However, when creating a plurality of unit spaces by dividing the data of the variable indicating the state of the plant as described above, the number of data constituting any of the plurality of unit spaces may become fewer depending on how the data is divided, which may lead to a decrease in the detection accuracy of an abnormality of the plant.

In view of the above, an object of at least one embodiment of the present invention is to provide a plant monitoring method, a plant monitoring device, and a plant monitoring program capable of accurately detecting an abnormality of a plant.

### Solution to the Problems

According to at least one embodiment of the present invention, a method of monitoring a plant by using a Mahalanobis distance calculated from data of a plurality of variables each of which indicates a state of the plant includes: a dividing step of dividing a range of a single variable which indicates a state of the plant into a plurality of first range bands on the basis of a frequency distribution of the single variable; and a unit space creating step of creating a plurality of unit spaces which serve as a basis of calculation of the Mahalanobis distance on the basis of the respective data of the plurality of variables respectively corresponding to a plurality of second range bands of the single variable determined on the basis of the plurality of first range bands.

Furthermore, according to at least one embodiment of the present invention, a plant monitoring device which uses a Mahalanobis distance calculated from data of a plurality of variables each of which indicates a state of the plant includes: a division part configured to divide a range of a single variable which indicates a state of the plant into a plurality of first range bands on the basis of a frequency distribution of the single variable; and a unit space creation part configured to create a plurality of unit spaces which serve as a basis of calculation of the Mahalanobis distance on the basis of the respective data of the plurality of variables respectively corresponding to a plurality of second range bands of the single variable determined on the basis of the plurality of first range bands.

Furthermore, according to at least one embodiment of the present invention, a program for monitoring a plant by using a Mahalanobis distance calculated from data of a plurality of variables each of which indicates a state of the plant causes a computer to perform: divide a range of a single variable which indicates a state of the plant into a plurality of first range bands on the basis of a frequency distribution of the single variable; and create each of a plurality of unit spaces which serve as a basis of calculation of the Mahalanobis distance on the basis of the respective data of the plurality of variables respectively corresponding to a plurality of second range bands of the single variable determined on the basis of the plurality of first range bands.

### Advantageous Effects

According to at least one embodiment of the present invention, it is possible to provide a plant monitoring method, a plant monitoring device, and a plant monitoring program capable of accurately detecting an abnormality of a plant.

### BRIEF DESCRIPTION OF DRAWINGS

FIG. 1 is a schematic configuration diagram of a gas turbine included in a plant to which a monitoring method according to an embodiment is to be applied.

FIG. 2 is a schematic configuration diagram of a steam turbine included in a plant to which a monitoring method according to an embodiment is to be applied.

FIG. 3 is a schematic configuration diagram of a plant monitoring device according to an embodiment.

FIG. 4 is a flowchart showing a method of monitoring a plant according to an embodiment.

FIG. 5 is a graph showing an example of the frequency distribution of the output (the single variable) of the plant.

FIG. 6 is a graph showing an example of the cumulative frequency distribution of the output (the single variable) of the plant.

FIG. 7 is a graph showing an example of the frequency distribution of the output (the single variable) of the plant.

FIG. 8 is a graph showing an example of the frequency distribution of the output (the single variable) of the plant.

FIG. 9 is a graph showing an example of the frequency distribution of the output (the single variable) of the plant.

FIG. 10 is a graph schematically showing a part of the frequency distribution of the output (the single variable) of the plant.

FIG. 11 is a diagram schematically showing an example of a unit space.

### DETAILED DESCRIPTION

Embodiments of the present invention will now be described in detail with reference to the accompanying drawings. It is intended, however, that unless particularly identified, dimensions, materials, shapes, relative positions and the like of components described in the embodiments shall be interpreted as illustrative only and not intended to limit the scope of the present invention.

(Configuration of a Plant Monitoring Device)

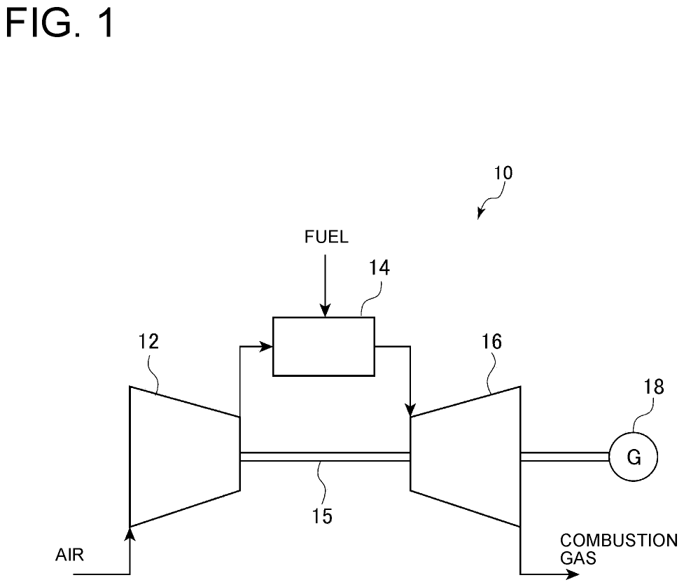

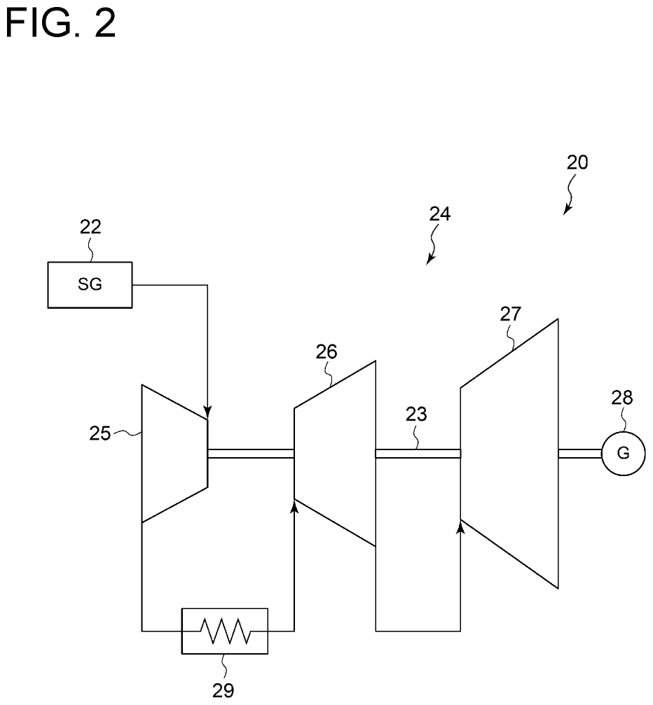

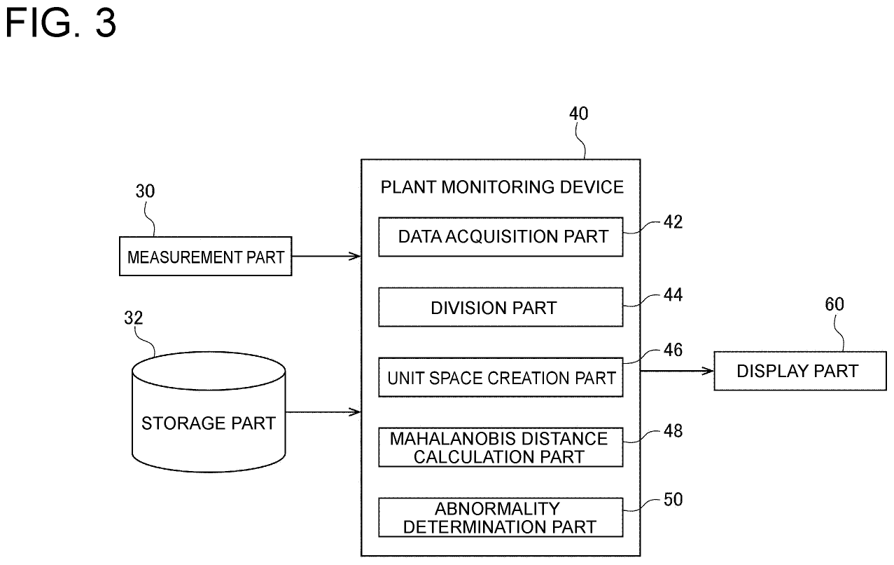

FIGS. 1 and 2 are each a schematic configuration diagram of an apparatus included in a plant to which a monitoring method according to some embodiments is to be applied. The apparatus illustrated in FIG. 1 is a gas turbine, and the apparatus illustrated in FIG. 2 is a steam turbine. FIG. 3 is a schematic configuration diagram of a plant monitoring device according to an embodiment.

The gas turbine 10 depicted in FIG. 1 includes a compressor 12 for compressing air, a combustor 14 for combusting a fuel with compressed air from the compressor 12, and a turbine 16 driven by combustion gas generated by the combustor 14. A generator 18 is coupled to a rotor of the gas turbine 10, such that the gas turbine 10 drives the generator 18 to rotate.

The steam turbine 20 depicted in FIG. 2 includes a boiler 22 for producing steam and a turbine 24 driven by steam from the boiler 22. The turbine 24 includes a high-pressure turbine 25, a mid-pressure turbine 26 whose inlet pressure is lower than that of the high-pressure turbine 25, and a low-pressure turbine 27 whose inlet pressure is lower than that of the mid-pressure turbine 26. A reheater 29 is disposed between the high-pressure turbine 25 and the mid-pressure turbine 26. A generator 28 is coupled to the rotor 23 of the steam turbine 20, such that the steam turbine 20 drives the generator 28 to rotate.

In some embodiments, the plant to be monitored includes the gas turbine 10 or the steam turbine 20 described above. In some embodiments, the plant to be monitored may include a turbine driven by renewable energy such as wind power and hydraulic power (such as a wind turbine and a waterwheel). In some embodiments, the plant to be monitored may include a machine other than a turbine.

The plant monitoring device 40 depicted in FIG. 3 is configured to monitor a plant on the basis of measurement values of a plurality of variables which indicate the state of the plant measured by a measurement part 30.

The measurement part 30 is configured to measure a plurality of variables which indicate the state of the plant. The measurement part 30 may include a plurality of sensors each configured to measure corresponding one of a plurality of variables each of which indicates the state of the plant.

In a case where the plant includes the gas turbine 10, the measurement part 30 may include a sensor configured to measure any one of the rotor rotation speed of the gas turbine 10, the blade path temperature of each stage, the average blade path temperature, the turbine inlet pressure, the turbine outlet pressure, or the generator output, as a variable which indicates the state of the plant. In a case where the plant includes the steam turbine 20, the measurement part 30 may include a sensor configured to measure any one of the rotor rotation speed of the steam turbine 20, the blade path temperature of each stage, the average blade path temperature, the turbine inlet pressure, the turbine outlet pressure, or the generator output, as a variable which indicates the state of the plant.

The plant monitoring device 40 is configured to receive a signal indicating a measurement value of a variable indicating the state of the plant from the measurement part 30. The plant monitoring device 40 may be configured to receive a signal indicating a measurement value from the measurement part 30 at an interval of a predetermined sampling cycle. Furthermore, the plant monitoring device 40 is configured to process the signal received from the measurement part 30 and determine presence or absence of an abnormality of the plant. The determination result obtained by the plant monitoring device 40 may be displayed by a display part 60 (display screen or the like).

As depicted in FIG. 3, the plant monitoring device 40 according to an embodiment includes a data acquisition part 2, a division part 44, a unit space creation part 46, a Mahalanobis distance calculation part 48, and an abnormality determination part 50.

The plant monitoring device 40 includes a calculator including a processor (CPU), a storage device (memory device; RAM and the like), an auxiliary storage part and an interface, for instance. The plant monitoring device 40 is configured to receive a signal indicating a measurement value of a variable indicating the state of the plant from the measurement part 30 via an interface. The processor is configured to process the accordingly received signals. Furthermore, the processor is configured to process a program expanded in the storage device. Accordingly, the respective functions of the above described functional parts (the data acquisition part 42 and the like) are realized.

The content of process at the plant monitoring device 40 is implemented as a program to be executed by the processor. The program may be stored in the auxiliary storage part. When the program is executed, the program is expanded in the storage part. The processor is configured to read out the program from the storage device, and executes the orders contained in the program.

The data acquisition part 42 is configured to acquire data of a single variable indicating the state of the plant and a plurality of variables (V1, V2, . . . , Vn) indicating the state of the plant at each of a plurality of points of time ‘t’ (t1, t2, . . . ). In the embodiment described below, the data acquisition part 42 is configured to acquire data of the output (p) of the plant as the single variable indicating the state of the plant. The output of the plant may be the output of a generator such as the generator 18 connected to the gas turbine 10 or the generator 28 connected to the steam turbine 20. In another embodiment, the data acquisition part 42 may be configured to acquire the rotation speed of a device constituting the plant, a numerical value related to oscillation of the device (e.g., a value indicating frequency or oscillation level), the temperature of the device, the temperature of the atmosphere, or the flow rate of the fuel supplied to the device (supply amount), as the single variable indicating the state of the plant.

The data acquisition part 42 may be configured to acquire the above described data on the basis of the measurement value of the output (single variable) of the plant or a plurality of variables measured by the measurement part 30. The measurement value of the output of the plant or the plurality of variables or the data based on the measurement value may be stored in the storage part 32. The data acquisition part 42 may be configured to acquire the above described measurement value or the data based on the measurement value from the storage part 32.

The storage part 32 may include a main storage part or an auxiliary storage part of a calculator that constitutes the plant monitoring device 40. Alternatively, the storage part 32 may include a remote storage device connected to the calculator via a network.

The division part 44 is configured to divide the output range of the plant into a plurality of first output bands (range bands) (A1, A2, . . . ) on the basis of the frequency distribution of the output (single variable) of the plant acquired by the data acquisition part 42.

The unit space creation part 46 is configured to determine a plurality of second output bands (range bands) (B1, B2, . . . ) on the basis of the plurality of first output bands obtained by the division part 44. Furthermore, the unit space creation part 46 is configured to create a plurality of unit spaces that serve as the basis of calculation of the Mahalanobis distance, on the basis of the data (measurement values) of the plurality of variables (V1, V2, . . . , Vn) respectively corresponding to the plurality of second output bands.

The above described unit space is a group (aggregate of normal data) that is homogenous with regard to a purpose, and the distance from the center of the unit space of the data to be evaluated is calculated as the Mahalanobis distance. The smaller the Mahalanobis distance, the higher the possibility of the data to be evaluated being normal. The greater the Mahalanobis distance, the higher the possibility of the data to be evaluated being abnormal.

The Mahalanobis distance calculation part 48 is configured to calculate the Mahalanobis distance for the data to be evaluated using the unit space corresponding to the output (single variable) of the plant at the time of acquisition of the data (measurement values) of the plurality of variables to be evaluated, from among the plurality of unit spaces created by the unit space creation part 46.

The abnormality determination part 50 is configured to determine presence or absence of an abnormality of the plant on the basis of the Mahalanobis distance calculated by the Mahalanobis distance calculation part 48.

(Flow of Plant Monitoring)

Hereinafter, the plant monitoring method according to some embodiments will be described in more detail. While the following description describes a case in which the above described plant monitoring device 40 is used to perform a plant monitoring method according to an embodiment, another device may be used to perform the plant monitoring method in some other embodiments.

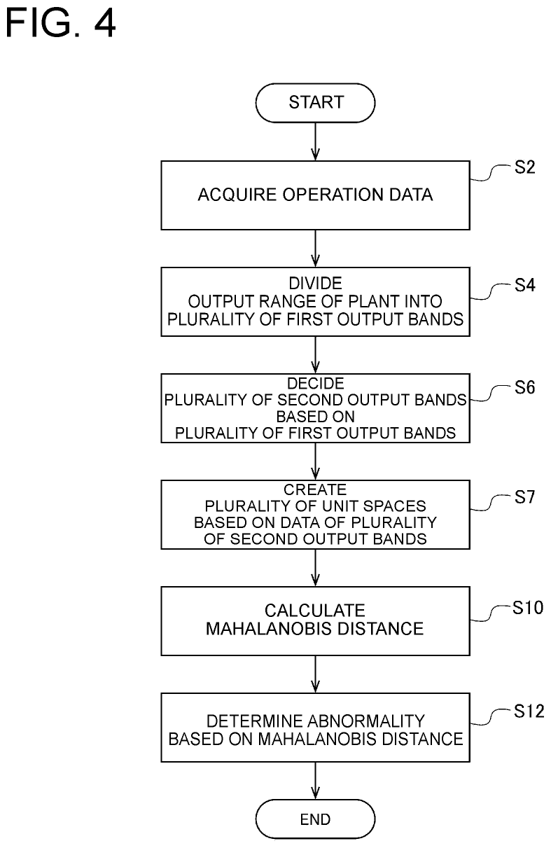

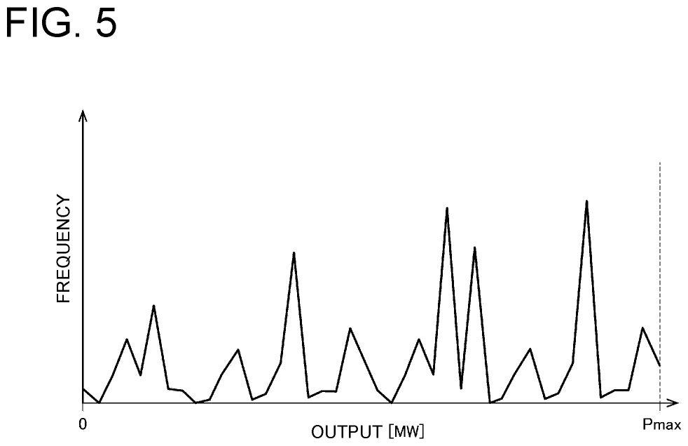

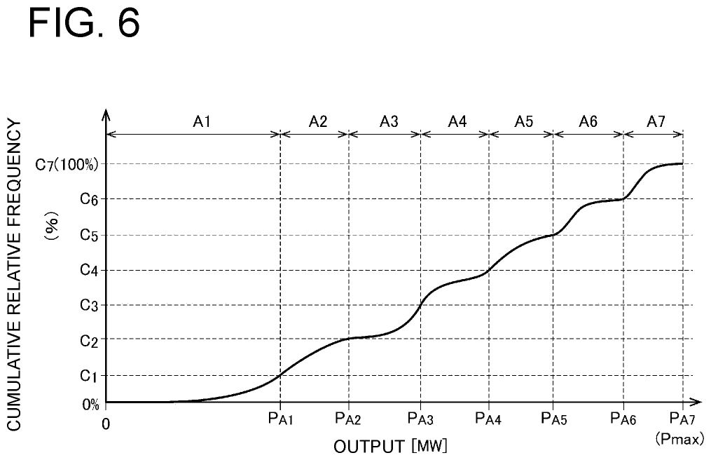

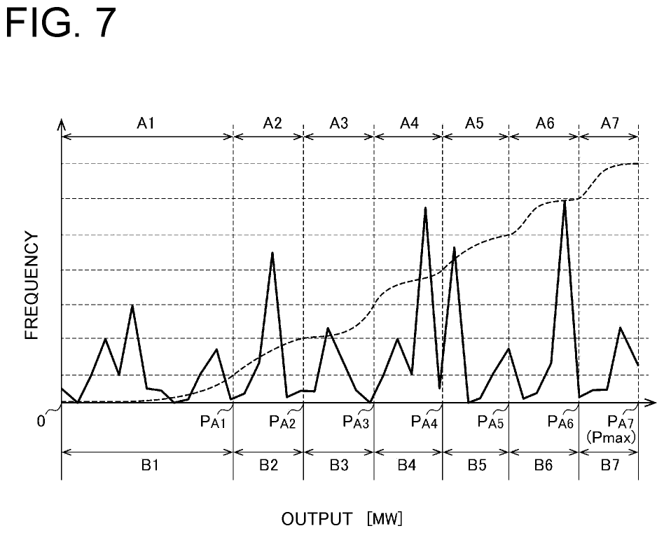

FIG. 4 is a flowchart showing a method of monitoring a plant according to some embodiments. FIGS. 5 to 9 are each a diagram for describing a method of monitoring a plant according to some embodiments. FIGS. 5 and 7 to 9 are each a graph showing an example of the frequency distribution (histogram) of the output of the plant (single variable), and FIG. 6 is a graph showing an example of the cumulative frequency distribution of the output of the plant (single variable). In FIGS. 5 and 7 to 9, the x-axis represents the output of the plant (single variable), and the y-axis represents the frequency of the output of the plant (single variable). In FIG. 6, the x-axis represents the output of the plant (single variable), and the y-axis represents the cumulative relative frequency of the output of the plant (single variable). In the graphs of FIGS. 7 to 9, the curve showing the cumulative relative frequency is drawn in broken lines.

In some embodiments, the data acquisition part 42 acquires the output of the plant (single variable) and the data of the plurality of variables indicating the state of the plant (S2). More specifically, in step S2, the output p (p1, p2, . . . ) of the plant corresponding to each of the plurality of points of time (t1, t2, . . . ) is acquired, and each of the data of ‘n’ variables (V1, V2, . . . , Vn) indicating the state of the plant corresponding to each of the plurality of points of time (t1, t2, . . . ) is acquired, respectively. The output of the plant corresponding to time ‘t’ or the above described data of the plurality of variables may be the representative value (e.g., average value) of the output of the plant or the measurement values of the plurality of variables in a predetermined period with reference to time ‘t’.

The ‘n’ variables indicating the state of the plant may include, for instance, at least one of the rotor rotation speed of the gas turbine 10 or the steam turbine 20, the blade path temperature of each stage, the blade path average temperature, the turbine inlet pressure, the turbine outlet pressure, or the generator output.

Next, the division part 44 divides the output range of the plant into a plurality of first output bands (range bands) (A1, A2, . . . ) on the basis of the frequency distribution of the output of the plant (S4). The frequency distribution of the output of the plant is acquirable on the basis of the output of the plant acquired in step S2.

FIG. 5 is a graph showing an example of the frequency distribution of the output p′ of the plant acquired in step S2. The graph in FIG. 5 shows the frequency distribution of a range where the output range of the plant is not smaller than 0 [MW] and not smaller than Pmax [MX].

In step S4, for instance, the range of each of the plurality of first output bands (A1, A2, . . . ) is determined such that the frequency of the output included in each of the plurality of first output bands (A1, A2, . . . ) does not vary considerably.

Herein, FIG. 6 is a graph showing the frequency distribution of the plant of the output shown in FIG. 5 converted into a cumulative frequency distribution. In some embodiments, in step S4, each range of the first output bands may be determined such that the relative frequencies of the output corresponding to the plurality of first output bands (A1, A2, . . . ) are distributed substantially equal (that is, the frequencies of the output corresponding to the plurality of first output bands are substantially equal) on the basis of the cumulative frequency distribution of the output of the plant.

An example of the above step will be described with reference to the graph of FIG. 6. On the premise that the cumulative relative frequency at the output zero is zero % and the cumulative relative frequency at the output Pmax is 100%, the cumulative relative frequency is divided into a plurality of ranges: not smaller than 0% and not greater than C1, greater than C1 and not greater than C2, greater than C3 and not greater than C4, greater than C4 and not greater than C5, greater than C5 and not greater than C6, and greater than C6 and not greater than C7 (=100%). The above plurality of ranges have substantially the same width of the relative frequency (that is, the frequency is substantially the same in the plurality of ranges). It is possible to determine the output bands corresponding to the plurality of ranges as the plurality of first output bands (A1 to A7). Herein, the range of the output [MW] of the first output bands A1 to A7 are, respectively, not smaller than zero and not greater than P_{A1}, greater than P_{A1} and not greater than P_{A2}, greater than P_{A2} and not greater than P_{A3}, greater than P_{A3} and not greater than P_{A4}, greater than P_{A4} and not greater than P_{A5}, greater than P_{A5} and not greater than P_{A6}, greater than P_{A6} and not greater than P_{A7}. Furthermore, the ratio of the frequencies of the output of the output bands A1 to A7 are represented respectively as follows: C1, (C2-C1), (C3-C2), (C4-C3), (C5-C4), (C6-C5), and (C7-C6).

In some embodiments, in step S4, the output range of the plant is divided such that the ratio of the frequencies of the output of the plant in any two output bands, of the plurality of first output bands (A1, A2, . . . ), is not smaller than 0.75 and not greater than 1.25. In the example shown in FIG. 6, it is possible to express the ratio of the frequencies of the output in the first output band A2 and the first output band A3 as (C3-C2)/(C2-C1), for instance.

In some embodiments, in step S4, the output range of the plant is divided such that the ratio of the frequencies of the output of the plant in at least two output bands, of the plurality of first output bands (A1, A2, . . . ) is 1.

In some embodiments, in step S4, the output range of the plant is divided such that the ratio of the frequencies of the output of the plant in any two output bands, of the plurality of first output bands (A1, A2, . . . ) is 1.

The following description is described based on the premise that the output range of the plant is divided into seven first output bands (A1 to A7) in step S4, as shown in FIG. 6.

Next, the unit space creation part 46 determines a plurality of second output bands (range bands) (B1, B2, . . . ) of the plant on the basis of the plurality of first output bands (A1 to A7). Herein, since the plurality of first output bands (A1 to A7) are set on the basis of the frequency distribution of the output of the plant, it can be said that the plurality of second output bands (B1, B2, . . . ) are also determined on the basis of the frequency distribution of the output of the plant. The step S6 will be described later in detail.

Next, the unit space creation part 46 creates a plurality of unit spaces (Q1, Q2, . . . ) that serve as the basis of calculation of the Mahalanobis distance, on the basis of the data of ‘n’ variables (the plurality of variables) (V1, V2, Vn) respectively corresponding to the plurality of second output bands (B1, B2, . . . ) determined in step S6 (S8).

Furthermore, the Mahalanobis distance calculation part 48 calculates the Mahalanobis distance for the data to be evaluated (signal space data) using the unit space corresponding to the output (single variable) of the plant at the time of acquisition of the data of ‘n’ variables (the plurality of variables) to be evaluated, from among the plurality of unit spaces (Q1, Q2, . . . ) created by the unit space creation part 46 (S10). For instance, in a case where the output of the plant at the acquisition time of the data of ‘n’ variables to be evaluated is included in the range of the second output band B2, the unit space Q2 corresponding to the second output band B2 is used to calculate the Mahalanobis distance D corresponding to the data to be evaluated.

The Mahalanobis distance corresponding to the data to be evaluated can be calculated by the method described in Patent Document 1. The method of calculating the Mahalanobis distance can be briefly described as follows. The method obtains the average of each item (variable) from the following expression (A) using the data constituting the unit space (data (X1, X2, . . . , Xn) of ‘n’ variables (V1, V2, . . . , Vn)). In the following expression, ‘k’ is the number of data of each of ‘n’ variables (number of data sets) constituting the unit space.

$$( Expression 1 )$$

$$\overline{{X}_{i}} = \frac{1}{k} {\sum }_{k} {X}_{ik} \qquad ( A )$$

Next, the method obtains the covariance matrix COV (n×n matrix) of the data constituting the unit space from the following expression (B) by using the average of each item (variable) calculated from the above expression (A).

$$( Expression 2 )$$

$${COV}_{ij} = \frac{1}{k} {\sum }_{k} ( {X}_{ik} - \overline{{X}_{i}} ) ( {X}_{jk} - \overline{{X}_{j}} ) \qquad ( B )$$

Then, using the data Y₁ to Yₙ to be evaluated and the inverse matrix of the average obtained from the above expression (A) and the covariance matrix obtained from the above expression (B), the square D² of the Mahalanobis distance D is calculated from the following expression (C). In the following expression, 1 is the number of data (data set number) of the data to be evaluated (signal space data) Y₁ to Yₙ corresponding to ‘n’ variables.

$$( Expression 3 )$$

$${D}^{2} = ( \begin{matrix}{Y}_{1 l} - \overline{{X}_{1}} & … & {Y}_{nl} - \overline{{X}_{n}}\end{matrix} ) {COV}^{- 1} ( \begin{matrix}{Y}_{1 l} - \overline{{X}_{1}} \\ ⋮ \\ {Y}_{nl} - \overline{{X}_{n}}\end{matrix} ) \qquad ( C )$$

Next, the abnormality determination part 50 determines presence or absence of an abnormality of the plant on the basis of the Mahalanobis distance D calculated in step S10 (S12). In step S12, presence or absence of an abnormality of the plant may be determined on the basis of comparison between the above described Mahalanobis distance D and a threshold value. For instance, it is determined that the plant is normal if the Mahalanobis distance D calculated in step S10 is not greater than a threshold value, and that the plant has an abnormality if the Mahalanobis distance is greater than the threshold value.

In the method according to the above described embodiment, the output range of the plant is divided into a plurality of first output bands (A1, A2, . . . ) on the basis of the frequency distribution of the output of the plant, and the plurality of unit spaces (Q1, Q2, . . . ) corresponding to the plurality of second output bands (B1, B2, . . . ) determined on the basis of the plurality of first output bands are created. That is, on the basis of the frequency distribution of the plant output, a plurality of output bands (the first output bands and the second output bands) corresponding respectively to the plurality of unit spaces are determined. Thus, by determining the plurality of output bands (the first output bands or the second output bands) such that the frequencies in the plurality of output bands are equal, for instance, it is easier to ensure a sufficient number of data of the plurality of variables (V1, V2, Vn) constituting each of the plurality of unit spaces. Or, it is easier to avoid an event where the number of data constituting any one of the plurality of unit spaces becomes too small. Thus, it is possible to detect an abnormality of the plant accurately on the basis of the Mahalanobis distance regardless of the output of the plant, and suppress erroneous detection and erroneous warnings, for instance.

Furthermore, in the above described embodiment, in step S4, if the output range of the plant is divided such that the ratio of the frequencies in any two output bands, of the plurality of first output bands (A1, A2, . . . ) is not smaller than 0.75 and not greater than 1.25, the frequencies of the output in the respective first output bands are substantially equal. Thus, it is easier to ensure a sufficient number of data of the plurality of variables constituting each of the plurality of unit spaces determined on the basis of the plurality of first output bands. Thus, it is possible to detect an abnormality of the plant accurately on the basis of the Mahalanobis distance regardless of the output of the plant.

Furthermore, in some embodiments, in step S4, if the output range of the plant is divided such that the ratio of the frequencies in at least two output bands, of the plurality of first output bands (A1, A2, . . . ) is 1, the frequencies of the output in at least two output bands of the plurality of first output bands are equal. Thus, it is easier to ensure a sufficient number of data of the plurality of variables constituting each of the plurality of unit spaces determined on the basis of the two output bands. Thus, it is possible to detect an abnormality of the plant accurately on the basis of the Mahalanobis distance regardless of the output of the plant.

In some embodiments, in step S6, the unit space creation part 46 determines a plurality of output bands corresponding to the plurality of first output bands (A1 to A7) as the second output bands (B1 to B7) of the plant. That is, as shown in FIG. 7, the output ranges of the plurality of second output bands (B1 to B7) are equal to the output ranges of the plurality of first output bands (A1 to A7), respectively.

According to the above described embodiment, it is possible to determine the plurality of second output bands (B1 to B7) as output bands that respectively correspond to the plurality of first output bands (A1 to A7) with a simple procedure. Thus, it is possible to detect an abnormality of the plant accurately on the basis of the Mahalanobis distance regardless of the output of the plant, with a more simplified procedure.

In some embodiments, in step S6, the unit space creation part 46 selects an output which serves as a boundary between the plurality of second output bands (B1, B2, . . . ) from among the plurality of first output bands (A1 to A7), and determines the plurality of output bands divided by the boundary as the plurality of second output bands.

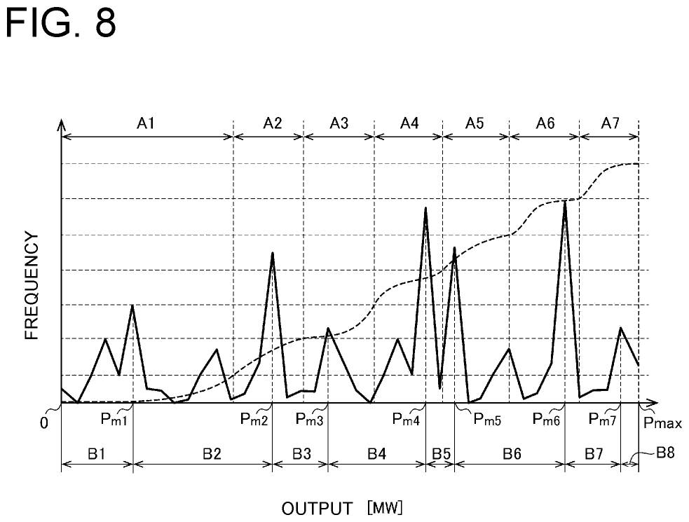

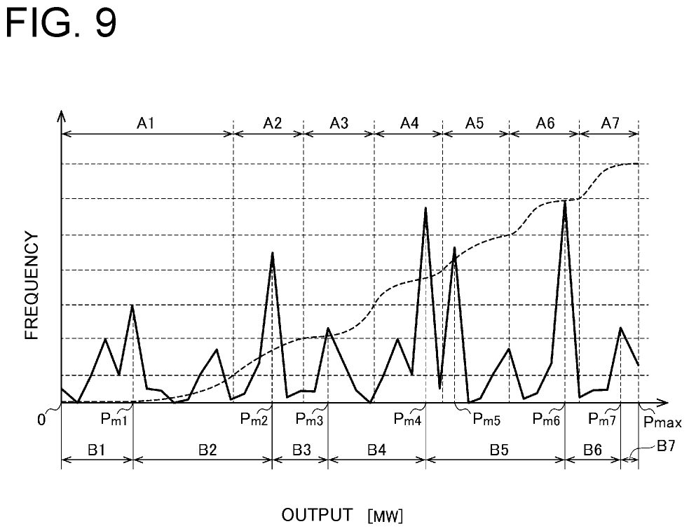

In some embodiments, as depicted in FIGS. 8 and 9, at least one of the mode values Pm1 to Pm7 of the respective outputs of the plurality of first output bands (A1 to A7) may be selected as a boundary between the plurality of the second output bands. In the example shown in FIG. 8, each of the mode values Pm1 to Pm7 of the respective outputs of the plurality of first output bands (A1 to A7) is selected as a boundary between the plurality of the second output bands. The output range (not smaller than zero and not greater than Pmax) of the plant is divided by the mode values Pm1 to Pm7, and thereby the plurality of second output bands (B1 to B8) are determined.

According to the above embodiment, at least one of the mode values (Pm1 to Pm7) respectively corresponding to the outputs of the plurality of first output bands (A1 to A7) are adopted as the boundary between the plurality of the second output bands (B1, B2, . . . ). Thus, in the graph (FIG. 8, 9, and the like) of the output relative frequency, each of the second output bands having the boundary as the upper limit or the lower limit (the pair of adjacent second output bands) includes at least a half of the peak area including the boundary. Thus, it is even easier to ensure the number of data constituting each of the unit spaces (Q1, Q2, . . . ) corresponding to the above second output bands (B1, B2, . . . ). Thus, it is possible to improve the accuracy of plant abnormality detection based on the Mahalanobis distance.

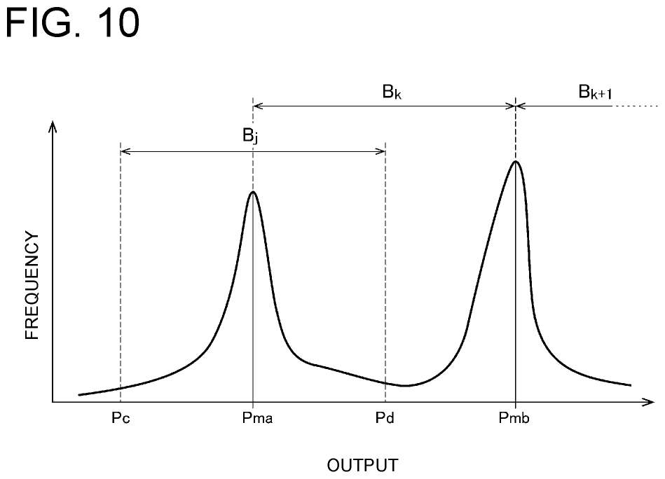

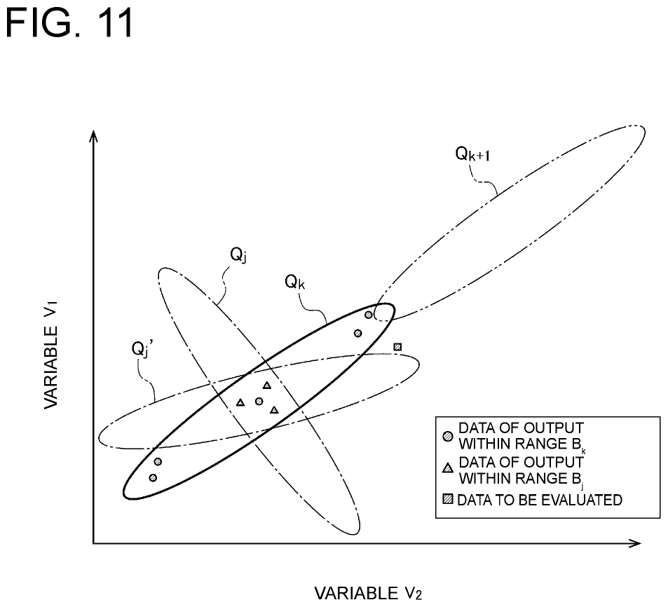

Herein, FIG. 10 is a graph schematically showing a part of the frequency distribution of the output of the plant. FIG. 11 is a diagram schematically showing an example of the unit space created on the basis of the frequency distribution of the output of the plant shown in FIG. 10. Herein, the output bands Bₖ and Bₖ₊₁ in FIG. 10 are output bands divided by the mode values Pma, Pmb of the output of the plant, and the output band Bⱼ is the output band divided by the outputs Pc, Pd between the mode values of the output of the plant. The ovals in FIG. 11 each represent a unit space (Qₖ, Qₖ₊₁, Qⱼ, and the like). Each oval is an aggregate of points having equal Mahalanobis distances calculated from the respective unit spaces.

The output band Bⱼ is divided by the outputs Pc, Pd between the mode values (Pma, Pmb, and the like) of the output. Thus, the data in the output band Bⱼ does not include so many data corresponding to the output in the vicinity of the lower limit output (Pc) and the upper limit output (Pd) of the output band Bⱼ, but includes a great number of data in the vicinity of the mode value Pma positioned between the lower limit and the upper limit. This means that, in the oval representing the unit space Q including data of the output band Bⱼ, the number of data positioned in the vicinity of opposite end portions of the longitudinal axis of the oval is small, and the number of data positioned in the vicinity of the center of the longitudinal axis of the oval is great (see FIG. 11). In this case, the shape of the oval (including the slope of the longitudinal axis) is not determined stably (see Qⱼ and Qⱼ′ in FIG. 11), and thus abnormality determination based on the Mahalanobis distance is not stable.

For instance, in a case where the data to be evaluated (signal space data) is represented as ‘d’ in the graph of FIG. 11, the Mahalanobis distance calculated on the basis of the unit space Qⱼ and the Mahalanobis distance calculated on the basis of the unit space Qⱼ′ are considerably different. That is, the Mahalanobis distance calculated on the basis of the unit space Qⱼ is relatively large, and the Mahalanobis distance calculated on the basis of the unit space Qⱼ′ is relatively small. Thus, the abnormality determination results based on the Mahalanobis distance may vary. Accordingly, for instance, the possibility of erroneous determination in the abnormality determination increases.

Meanwhile, the output band Bₖ is divided by the mode values Pma, Pmb of the output. Thus, the data in the output band Bₖ includes a relatively large number of data corresponding to the output in the vicinity of the lower limit output (Pma) and the upper limit output (Pmb) of the output band Bₖ. This means that, in the oval representing the unit space Qₖ including data of the output band Bₖ, a large number of data are positioned in the vicinity of opposite end portions of the longitudinal axis of the oval (see FIG. 11). In this case, the shape of the oval (including the slope of the longitudinal axis) is determined stably. Thus, it is possible to obtain the calculation result of the Mahalanobis distance stably, and perform abnormality determination stably.

Furthermore, also for the oval representing the unit space Qₖ₊₁ consisting of the data in the output band Bₖ₊₁ next to the output band Bₖ, the shape of the oval (including the slope of the longitudinal axis) is determined stably, and the two ovals connect to one another smoothly (for instance, the two ovals have similar slopes). Thus, during operation of the plant, it is possible to stably perform abnormality determination even in a case where the output of the plant changes across the boundary (Pmb in FIG. 10) of the output band Bₖ and the output band Bₖ₊₁.

In this regard, according to the above described embodiment, the mode values Pm1 to Pm7 of the output in the first output band (A1 to A7) are used as the boundaries between the plurality of second output bands (B1, B2, . . . ). Thus, the data of the second output band having the boundary as the upper limit or the lower limit includes a relatively large number of data corresponding to the output in the vicinity of the boundary (the upper limit or the lower limit). Thus, the unit spaces (Q1, Q2, . . . ) created on the basis of the data in the second output bands (B1, B2, . . . ) are likely to connect to one another smoothly. Thus, even in a case where the output of the plant changes across the above described boundary, it is possible to detect an abnormality of the plant stably.

In some embodiments, in step S6, if the difference between a pair of adjacent mode values of the output is less than a predetermined value, the mode value having a larger frequency is selected as the boundary between the second output bands, of the pair of mode values of the output, and the mode value with a smaller frequency is not selected as the boundary between the second output bands.

For instance, in the example shown in FIG. 9, of the mode values Pm1 to Pm7 of the output in the respective first output bands (A1 to A7), the difference between the pair of adjacent mode values Pm4, Pm5 is small, and less than the predetermined value. Thus, of the mode values Pm4, Pm5, the mode value Pm4 of a greater frequency is selected as the boundary between the second output bands and the mode value Pm5 of a smaller frequency is not selected as the boundary between the second output bands. As a result, by dividing the output range (not smaller than zero and not greater than Pmax) of the plant with the mode values other than the mode value Pm5 (that is, Pm1 to Pm4, Pm6, and Pm7) from among the mode values Pm1 to Pm7, the plurality of second output bands (B1 to B7) are determined.

The output at which the frequency of the output of the plant reaches its peak may vary slightly in response to the change of the season, for instance, in which case the outputs appear on the graph of frequency distribution as separate peaks positioned proximate to one another. If data corresponding to the outputs of the plurality of peaks are included in separate unit spaces, it may be difficult to perform abnormality detection based on the Mahalanobis distance stably. In this regard, according to the above described embodiment, of the mode values (Pm1 to Pm7) of the output of the respective first output bands (A1 to A7), if the difference between a pair of adjacent mode values (Pm4, Pm5) is less than a predetermined value (that is, the above described peaks are close to one another), only the mode value of a larger frequency (Pm4) is selected as the boundary between the plurality of second output bands (B1, B2, . . . ) from the pair of mode values. Accordingly, it is possible to include data corresponding to the two mode values (Pm4, Pm5) in the same unit space, and thus it is possible to perform abnormal detection of the plant stably.

The contents described in the above respective embodiments can be understood as follows, for instance.

(1) According to at least one embodiment of the present invention, a method of monitoring a plant by using a Mahalanobis distance calculated from data of a plurality of variables each of which indicates a state of the plant includes: a dividing step (S4) of dividing a range of a single variable (e.g., the output of the plant) which indicates a state of the plant into a plurality of first range bands (e.g., the above described plurality of first output bands A1, A2, . . . ) on the basis of a frequency distribution of the single variable; and a unit space creating step (S4 to S6) of creating a plurality of unit spaces which serve as a basis of calculation of the Mahalanobis distance on the basis of the respective data of the plurality of variables respectively corresponding to a plurality of second range bands (e.g., the above described plurality of output bands B1, B2, . . . ) of the single variable determined on the basis of the plurality of first range bands.

According to the above method (1), the range of the single variable of the plant is divided into a plurality of first range bands on the basis of the frequency distribution of the single variable of the plant, and the plurality of unit spaces corresponding to the plurality of second range bands determined on the basis of the plurality of first range bands are created. That is, on the basis of the frequency distribution of the single variable, a plurality of range bands (the first range bands and the second range bands) corresponding respectively to the plurality of unit spaces are determined. Thus, by determining the plurality of range bands (the first range bands or the second range bands) such that the frequencies in the plurality of range bands are equal, for instance, it is easier to ensure a sufficient number of data of the plurality of variables constituting each of the plurality of unit spaces. Thus, it is possible to detect an abnormality of the plant accurately on the basis of the Mahalanobis distance regardless of the value of the single variable.

(2) In some embodiments, in the above method (1), the dividing step includes dividing the range of the single variable so that a ratio of frequencies of the single variable in any two range bands of the plurality of first range bands is not smaller than 0.75 and not greater than 1.25.

According to the above method (2), the range of the single variable is divided so that a ratio of frequencies of the single variable in any two range bands of the plurality of first range bands is not smaller than 0.75 and not greater than 1.25. That is, the frequency of the single variable in each of the plurality of first range bands is substantially equal. Thus, it is easier to ensure a sufficient number of data of the plurality of variables constituting each of the plurality of unit spaces determined on the basis of the plurality of first range bands. Thus, it is possible to detect an abnormality of the plant accurately on the basis of the Mahalanobis distance regardless of the value of the single variable.

(3) In some embodiments, in the above method (1) or (2), the dividing step includes dividing the range of the single variable so that a ratio of frequencies of the single variable in at least two range bands of the plurality of first range bands is 1.

According to the above method (3), the range of the single variable is divided so that a ratio of frequencies in any two range bands of the plurality of first range bands is 1. That is, the frequencies of the single variable in at least two of the plurality of first range bands are substantially equal. Thus, it is easier to ensure a sufficient number of data of the plurality of variables constituting each of the plurality of unit spaces determined on the basis of the two range bands. Thus, it is possible to detect an abnormality of the plant accurately on the basis of the Mahalanobis distance regardless of the value of the single variable.

(4) In some embodiments, in any one of the above methods (1) to (3), the plurality of second range bands correspond to the plurality of first range bands respectively.

According to the above method (4), it is possible to determine the plurality of second range bands as range bands that respectively correspond to the plurality of first range bands with a simple procedure. Thus, it is possible to detect an abnormality of the plant accurately on the basis of the Mahalanobis distance regardless of the value of the single variable with a more simplified procedure.

(5) In some embodiments, in any one of the above methods (1) to (3), the method includes a boundary selecting step of selecting, from the plurality of first range bands, a value of the single variable as a boundary between the plurality of second range bands.

According to the above method (5), a boundary between the plurality of second range bands is selected from the plurality of first range bands. Thus, it is possible to set a more appropriate boundary for creating a plurality of unit spaces in accordance with the frequency distribution of the single variable, compared to a case where the boundaries between the plurality of first range bands are directly used as the boundaries between the plurality of second range bands. Thus, it is possible to improve the accuracy of plant abnormality detection based on the Mahalanobis distance.

(6) In some embodiments, in the above method (5), the boundary selecting step includes selecting at least one of respective mode values (e.g., the above described mode values Pm1, Pm2 . . . of the output) of the single variable in the plurality of first range bands as the boundary between the plurality of second range bands.

According to the above method (6), at least one of the mode values of the single variable of the plurality of first range bands is used as the boundary between the plurality of the second range bands. Thus, in the graph of relative frequency of the single variable (e.g., output), each of the second range bands having the boundary as the upper limit or the lower limit (the pair of adjacent second range bands) includes at least a half of the peak area that includes the boundary. Thus, it is even easier to ensure the number of data constituting each of the unit spaces corresponding to the above second range bands. Thus, it is possible to improve the accuracy of plant abnormality detection based on the Mahalanobis distance.

Furthermore, according to the above method (6), the mode values of the single variable in the first output band are used as the boundaries between the plurality of second range bands. Thus, the data of the second range band having the boundary as the upper limit or the lower limit includes a relatively large number of data corresponding to the value of the single variable in the vicinity of the boundary (the upper limit or the lower limit). Thus, the unit spaces created on the basis of the data in the second range bands are likely to connect to one another smoothly. Thus, even in a case where the single variable of the plant changes across the above described boundary, it is possible to detect an abnormality of the plant stably.

(7) In some embodiments, in the above method (6), the boundary selecting step includes selecting a mode value of a greater frequency as the boundary and not selecting a mode value of a smaller frequency as the boundary from among a pair of adjacent mode values of the single variable, if a difference between the pair of mode values of the single variable is less than a predetermined value.

The value of the single variable at which the frequency of the single variable reaches its peak may vary slightly in response to the change of the season, for instance, in which case the values appear on the graph of frequency distribution as separate peaks positioned proximate to one another. If data corresponding to the single variable of the plurality of peaks are included in separate unit spaces, it may be difficult to perform abnormality detection based on the Mahalanobis distance stably. In this regard, according to the above method (7), of the mode values of the single variable of the respective first range bands, if the difference between a pair of adjacent mode values is less than a predetermined value (that is, the above described peaks are close to one another), only the mode value of a larger frequency is selected as the boundary between the plurality of second range bands from the pair of mode values. Accordingly, it is possible to include data corresponding to the two mode values in the same unit space, and thus it is possible to perform abnormal detection of the plant stably.

(8) In some embodiments, in any one of the above methods (1) to (7), the plant includes a gas turbine (10) or a steam turbine (20), the single variable indicating the state of the plant is an output of the plant, and the output of the plant includes an output of a generator (18, 28) connected to the gas turbine or the steam turbine.

According to the above method (8), on the basis of the frequency distribution of the output of the generator connected to the gas turbine or the steam turbine, a plurality of range bands (the first range bands and the second range bands) corresponding respectively to the plurality of unit spaces are determined. Thus, it is easier to ensure a sufficient number of data constituting each of the plurality of unit spaces. Thus, it is possible to detect an abnormality accurately for the plant including the gas turbine or the steam turbine on the basis of the Mahalanobis distance regardless of the output of the plant.

(9) According to at least one embodiment, a plant monitoring device (40) is a plant monitoring device which uses a Mahalanobis distance calculated from data of a plurality of variables each of which indicates a state of the plant, and includes: a division part (44) configured to divide a range of a single variable which indicates a state of the plant into a plurality of first range bands on the basis of a frequency distribution of the single variable; and a unit space creation part (46) configured to create a plurality of unit spaces which serve as a basis of calculation of the Mahalanobis distance on the basis of the respective data of the plurality of variables respectively corresponding to a plurality of second range bands of the single variable determined on the basis of the plurality of first range bands.

According to the above configuration (9), the range of the single variable of the plant is divided into a plurality of first range bands on the basis of the frequency distribution of the single variable of the plant, and the plurality of unit spaces corresponding to the plurality of second range bands determined on the basis of the plurality of first range bands are created. That is, on the basis of the frequency distribution of the single variable, a plurality of range bands (the first range bands and the second range bands) corresponding respectively to the plurality of unit spaces are determined. Thus, by determining the plurality of range bands (the first range bands or the second range bands) such that the frequencies in the plurality of range bands are equal, for instance, it is easier to ensure a sufficient number of data of the plurality of variables constituting each of the plurality of unit spaces. Thus, it is possible to detect an abnormality of the plant accurately on the basis of the Mahalanobis distance regardless of the value of the single variable.

(10) According to at least one embodiment, a program for monitoring a plant by using a Mahalanobis distance calculated from data of a plurality of variables each of which indicates a state of the plant causes a computer to perform: divide a range of a single variable which indicates a state of the plant into a plurality of first range bands on the basis of a frequency distribution of the single variable; and create each of a plurality of unit spaces which serve as a basis of calculation of the Mahalanobis distance on the basis of the respective data of the plurality of variables respectively corresponding to a plurality of second range bands of the single variable determined on the basis of the plurality of first range bands.

According to the above program (10), the range of the single variable indicating the state of the plant is divided into a plurality of first range bands on the basis of the frequency distribution of the single variable, and the plurality of unit spaces corresponding to the plurality of second range bands determined on the basis of the plurality of first range bands are created. That is, on the basis of the frequency distribution of the single variable, a plurality of range bands (the first range bands and the second range bands) corresponding respectively to the plurality of unit spaces are determined. Thus, by determining the plurality of range bands (the first range bands or the second range bands) such that the frequencies in the plurality of range bands are equal, for instance, it is easier to ensure a sufficient number of data of the plurality of variables constituting each of the plurality of unit spaces. Thus, it is possible to detect an abnormality of the plant accurately on the basis of the Mahalanobis distance regardless of the value of the single variable.

Embodiments of the present invention were described in detail above, but the present invention is not limited thereto, and various amendments and modifications may be implemented.

Further, in the present specification, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same” “equal” and “uniform” shall not be construed as indicating only the state in which the feature is strictly equal, but also includes a state in which there is a tolerance or a difference that can still achieve the same function.

Further, for instance, an expression of a shape such as a rectangular shape or a cylindrical shape shall not be construed as only the geometrically strict shape, but also includes a shape with unevenness or chamfered corners within the range in which the same effect can be achieved.

On the other hand, an expression such as “comprise”, “include”, “have”, “contain” and “constitute” are not intended to be exclusive of other components.

### REFERENCE SIGNS LIST

10 Gas turbine
12 Compressor
14 Combustor
15 Rotor
16 Turbine
18 Generator
20 Steam turbine
22 Boiler
23 Rotor
24 Turbine
25 High-pressure turbine
26 Mid-pressure turbine
27 Low-pressure turbine
28 Generator
29 Reheater
30 Measurement part
32 Storage part
40 Plant monitoring device
42 Data acquisition part
44 Division part
46 Unit space creation part
48 Mahalanobis distance calculation part
50 Abnormality determination part
60 Display part
A1 to A7 First output band
B1 to B8 Second output band

1. A method of monitoring a plant by using a Mahalanobis distance calculated from data of a plurality of variables each of which indicates a state of the plant, the method comprising:
a dividing step of dividing a range of a single variable which indicates a state of the plant into a plurality of first range bands on the basis of a frequency distribution of the single variable; and
a unit space creating step of creating a plurality of unit spaces which serve as a basis of calculation of the Mahalanobis distance on the basis of the respective data of the plurality of variables respectively corresponding to a plurality of second range bands of the single variable determined on the basis of the plurality of first range bands.

2. The method of monitoring a plant according to claim 1,
wherein the dividing step includes dividing the range of the single variable so that a ratio of frequencies of the single variable in any two range bands of the plurality of first range bands is not smaller than 0.75 and not greater than 1.25.

3. The method of monitoring a plant according to claim 1,
wherein the dividing step includes dividing the range of the single variable so that a ratio of frequencies of the single variable in at least two range bands of the plurality of first range bands is 1.

4. The method of monitoring a plant according to claim 1,
wherein the plurality of second range bands correspond to the plurality of first range bands respectively.

5. The method of monitoring a plant according to claim 1, comprising:
a boundary selecting step of selecting, from the plurality of first range bands, a value of the single variable as a boundary between the plurality of second range bands.

6. The method of monitoring a plant according to claim 5,
wherein the boundary selecting step includes selecting at least one of respective mode values of the single variable in the plurality of first range bands as the boundary between the plurality of second range bands.

7. The method of monitoring a plant according to claim 6,
wherein the boundary selecting step includes selecting a mode value of a greater frequency as the boundary and not selecting a mode value of a smaller frequency as the boundary from among a pair of adjacent mode values of the single variable, if a difference between the pair of mode values of the single variable is less than a predetermined value.

8. The method of monitoring a plant according to claim 1,
wherein the plant includes a gas turbine or a steam turbine,
wherein the single variable indicating the state of the plant is an output of the plant, and
wherein the output of the plant includes an output of a generator connected to the gas turbine or the steam turbine.

9. A plant monitoring device which uses a Mahalanobis distance calculated from data of a plurality of variables each of which indicates a state of the plant, the plant monitoring device comprising:
a division part configured to divide a range of a single variable which indicates a state of the plant into a plurality of first range bands on the basis of a frequency distribution of the single variable; and
a unit space creation part configured to create a plurality of unit spaces which serve as a basis of calculation of the Mahalanobis distance on the basis of the respective data of the plurality of variables respectively corresponding to a plurality of second range bands of the single variable determined on the basis of the plurality of first range bands.

10. A program for monitoring a plant by using a Mahalanobis distance calculated from data of a plurality of variables each of which indicates a state of the plant which causes a computer to perform:
divide a range of a single variable which indicates a state of the plant into a plurality of first range bands on the basis of a frequency distribution of the single variable; and
create each of a plurality of unit spaces which serve as a basis of calculation of the Mahalanobis distance on the basis of the respective data of the plurality of variables respectively corresponding to a plurality of second range bands of the single variable determined on the basis of the plurality of first range bands.
